(19) United States
(12) Patent Application Publication
(10) Pub. No.: US 2024/0188153 A1
(43) Pub. Date: Jun. 6, 2024

(54) NR POSITIONING - METHODS FOR RESOURCE PROVISION IN SIDELINK POSITIONING

(71) Applicant: INTERDIGITAL PATENT HOLDINGS, INC., Wilmington, DE (US)

(72) Inventors: Tuong Hoang, Montreal (CA); Fumihiro Hasegawa, Westmount (CA); Jaya Rao, Montreal (CA); Moon IL Lee, Melville, NY (US); Paul Marinier, Brossard (CA); Ghyslain Pelletier, Montreal (CA); Aata El Hamss, Laval (CA)

(73) Assignee: INTERDIGITAL PATENT HOLDINGS, INC., Wilmington, DE (US)

(21) Appl. No.: 18/284,915

(22) PCT Filed: Mar. 30, 2022
(86) PCT No.: PCT/US2022/022586

§ 371 Date: Sep. 29, 2023

Related U.S. Application Data
(60) Provisional application No. 63/167,978, filed on Mar. 30, 2021.
(60) Provisional application No. 63/249,501, filed on Sep. 28, 2021.

(51) Int. Cl. H04W 76/14; H04W 92/18

(52) U.S. Cl. CPC H04W 76/14; H04W 92/18

(57) ABSTRACT

The system and method includes PRS scheduling, SL-PRS request and transmission. PRS measurement and report, and autonomous positioning transmission and reporting. The system and method for a WTRU to provision sidelink positioning includes configuring the WTRU with a sidelink positioning service and an associated destination identification (ID), receiving DL-PRS and measurement reporting configuration from a network, transmitting an SL (sidelink)-PRS (positioning reference signal) transmission/reception request using the destination ID to at least one other WTRU requesting the at least one other WTRU to transmit SL-PRS, the request including at least one parameter based on the received measurement reporting configuration and QoS of a positioning service, and performing a PRS measurement and reporting the measurement to the network.

### CROSS REFERENCE TO RELATED APPLICATIONS

This application claims the benefit of U.S. Provisional Application Ser. No. 63/167,978 filed Mar. 30, 2021 and U.S. Provisional Application Ser. No. 63/249,501 filed Sep. 28, 2021, the contents of which are hereby incorporated by reference herein.

### BACKGROUND

New radio (NR) vehicular communications (V2X) is being configured to support sidelink communication among different vehicles. The resource for sidelink communication can be structured as resource pools. And may include defined channel design and scheduling.

### SUMMARY

The system and method includes PRS scheduling, SL-PRS request and transmission, PRS measurement and report, and autonomous positioning transmission and reporting. The system and method includes the target WTRU determining whether to request SL-PRS transmission from one or multiple anchor WTRUs based on positioning QoS requirements. The determining may be as determined by the DL-PRS configuration (e.g., the number of TRPs, the number of repetitions, and the periodicity of the DL-PRSs), the set of detected anchor WTRUs and/or the SL-PRS transmission pattern (e.g., the offset, periodicity, and number of repetitions) of one or multiple detected anchor WTRUs, the result of DL-PRS measurement and/or SL-PRS measurement/detection (e.g., whether DL-RSRP is smaller than a threshold, whether DL-PRS reception is deprioritized, whether NLOS of one or multiple TRPs are detected, etc.). The WTRU may broadcast/groupcast the SL-PRS transmission request using the destination ID associated with the positioning service. The content of the transmitted request message may include the validity time of the request (e.g., the expected time of the first SL-PRS transmission), the type of SL-PRS transmission request (aperiodic vs. periodic SL-PRS transmission), the set of anchor WTRUs and/or the set of SL-PRS resources, the requested SL-PRS pattern (e.g., offset, periodicity, and number of repetitions), and the priority of the request message. The WTRU may then perform SL-PRS and/or DL-PRS measurement and report both measurement to the network.

The system and method includes a target WTRU that performs sidelink positioning measurement and reporting. The sidelink positioning measurement and reporting include the WTRU being (pre-)configured with DL-PRS and SL-PRS reception from LMF/gNB, performing SL-PRS measurement in a (pre-)configured sidelink resource pool, and determining the anchor WTRU IDs associated to the detected SL-PRS. The anchor WTRU IDs associated to the detected SL-PRS may be based on the characteristics of the detected SL-PRS (resource, signals/sequence index), the zone ID associated with the detected SL-PRS resource, and the SL-PRS resource pool configuration. The WTRU may report SL-PRS measurements and associated anchor WTRU IDs.

The system and method for a WTRU to provision sidelink positioning includes configuring the WTRU with a sidelink positioning service and an associated destination identification (ID), receiving DL-PRS and measurement reporting configuration from a network, transmitting an SL (sidelink)-PRS (positioning reference signal) transmission/reception request using the destination ID to at least one other WTRU requesting the at least one other WTRU to transmit SL-PRS, the request including at least one parameter based on the received measurement reporting configuration and QoS of a positioning service, and performing a PRS measurement and reporting the measurement to the network.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates a diagram of DL based PRS configuration and measurement reporting;

FIG. 3 illustrates sidelink (SL)-PRS resource pool (pre-)configuration;

FIG. 4 illustrates a method configured for a WTRU in the sidelink positioning service;

FIG. 5 depicts a diagram of DL based Uu-PRS and measurement reporting configuration;

FIG. 6 depicts a diagram of DL based Uu-PRS and measurement reporting configuration; and

FIG. 7 illustrates a method 700 of measurement reporting.

### DETAILED DESCRIPTION

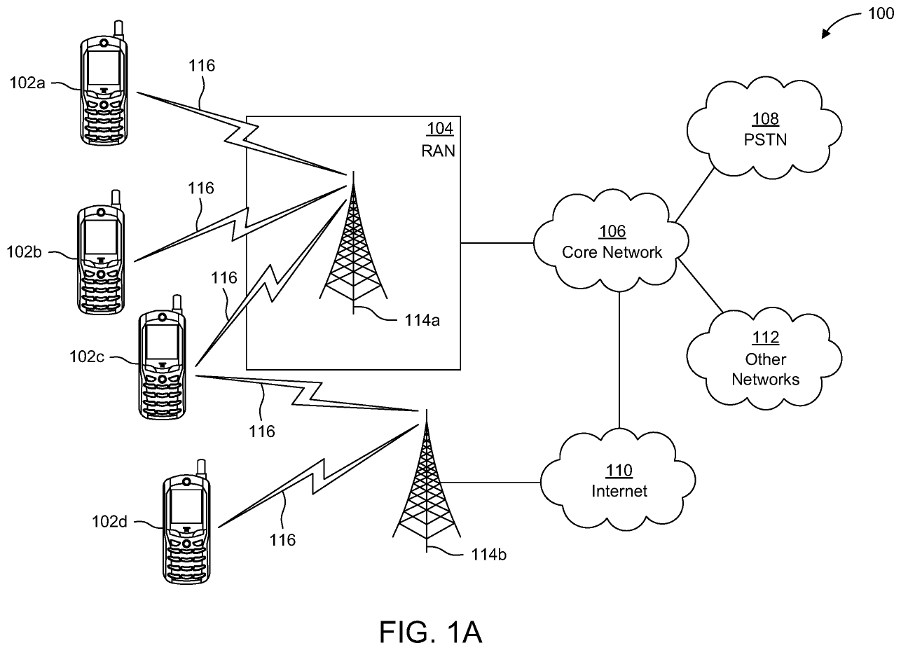

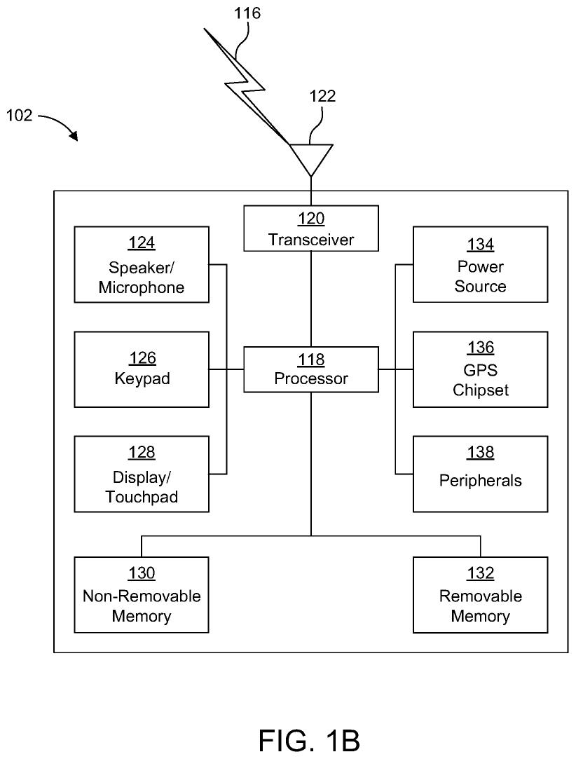

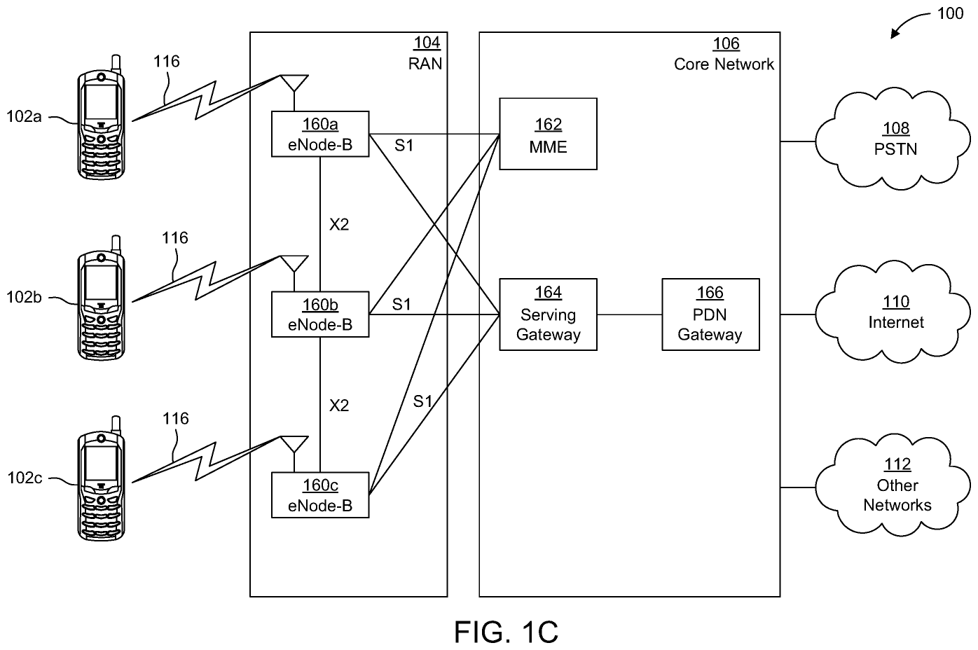

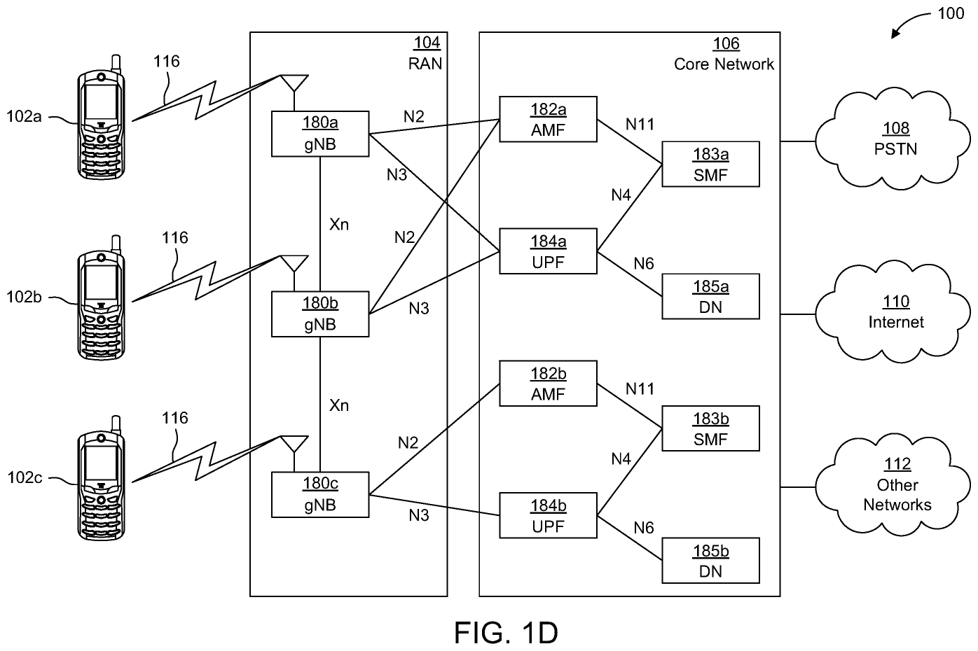

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the description contemplates any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHz, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHZ, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In a first example, a target WTRU determines whether to request SL-PRS transmission from one or multiple anchor WTRUs based on positioning QoS requirements. For example, the WTRU may determine by the DL-PRS configuration including the number of TRPs, the number of repetitions, and the periodicity of the DL-PRSs. For example, the WTRU may determine by the set of detected anchor WTRUs and/or the SL-PRS transmission pattern including the offset, periodicity, and number of repetitions, of one or multiple detected anchor WTRUs. For example, the WTRU may determine by the result of DL-PRS measurement and/or SL-PRS measurement/detection including whether DL-RSRP is smaller than a threshold, whether DL-PRS reception is deprioritized, whether NLOS of one or multiple TRPs are detected, etc. The WTRU may broadcast/groupcast the SL-PRS transmission request using the destination ID associated with the positioning service. The content of the transmitted request message may include one or more of the validity time of the request including the expected time of the first SL-PRS transmission, the type of SL-PRS transmission request, such as aperiodic and periodic SL-PRS transmission, the set of anchor WTRUs and/or the set of SL-PRS resources, the requested SL-PRS pattern including offset, periodicity, and number of repetitions, and the priority of the request message. The WTRU may perform SL-PRS and/or DL-PRS measurement and report both measurement to the network.

In an example, a target WTRU performs sidelink positioning measurement and reporting by the WTRU being (pre-)configured with DL-PRS and SL-PRS reception from LMF/gNB, the WTRU performing SL-PRS measurement in a (pre-)configured sidelink resource pool, the WTRU determining the anchor WTRU IDs associated to the detected SL-PRS based on the characteristics of the detected SL-PRS (resource, signals/sequence index), the zone ID associated with the detected SL-PRS resource, and the SL-PRS resource pool configuration. The WTRU reports SL-PRS measurements and associated anchor WTRU IDs.

NR V2X includes support of sidelink communication among different vehicles.

For sidelink resource, in NR V2X, the resource for sidelink transmission/reception is structured as resource pools. The resource pool includes of a set of continuous frequency resources repeating in time following a bitmap pattern. A WTRU may be configured one or multiple resource pool. For in coverage WTRUs, the resource pool can be configured via SIB/RRC. For out of coverage WTRUs, the resource pool can be pre-configured.

As provided herein, resource selection window may be used interchangeably with the minimum resource selection window and/or the maximum resource selection window.

For channel design, each sidelink transmission span within one slot consisting of PSSCH and PSCCH. PSSCH and PSCCH are FDM and TDM multiplexing. Sidelink control information (SCI) is divided into two parts which are the first stage SCI and the second stage SCI. The first stage SCIs indicate the resource used for sidelink transmission, the QoS of the transmission (e.g., priority), DMRS, PTRS used for the sidelink transmission and the second SCI format. The second stage SCI indicate the remaining control information. SCI can be used to reserve the resource for future transmission within a resource pool.

From the sidelink scheduling perspective, the sidelink resource may be scheduled by the network (i.e., Mode 1) and autonomously selected by the WTRU (i.e., Mode 2). If the WTRU perform Mode 2, it may perform sensing by decoding SCI from other WTRUs before selecting the sidelink resources to avoid selecting the resources reserved by other WTRUs.

SL-CSI-RS is supported for unicast to support the Tx WTRU in determination of Tx parameters (e.g., power and rank). Tx WTRU will indicate the presence of SL-CSI-RS by using SCI. CSI-RS transmission will trigger CSI reporting. And CSI reporting latency is configured via PC5 RRC. Each reporting is associated with one SL-CSI-RS transmission.

NR positioning may utilize DL-based, UL-based, and DL+UL-based positioning methods. In the DL-based positioning method, DL-PRS are sent from multiple TRPs to the WTRU. The WTRU may observe measure downlink signals from the TRPs. For the WTRU-B method, the WTRU may calculate its position and for WTRU-A method, the WTRU may return the downlink measurement to the network. For angle-based method, the WTRU may report the AoA and RSRP of the downlink signals from the TRPs. For timing-based method, the WTRU may report RSTD. The above methods require the transmission timing synchronization among the TRPs. The positioning calculation errors may come from synchronization error and multipath.

In the UL-based positioning methods, the WTRU sends UL-PRS for positioning, configured by RRC, to the TRP. The network may calculate the position of the WTRU based on the coordination of all the TRPs receiving UL-PRS from the WTRU.

In the UL and DL-based methods, WTRU measures Rx-Tx time difference between received DL-PRS and UL-PRS transmitted. The Rx-Tx time difference and RSRP are reported to the network. The network may then coordinate the TRPs to calculate the position of the WTRU.

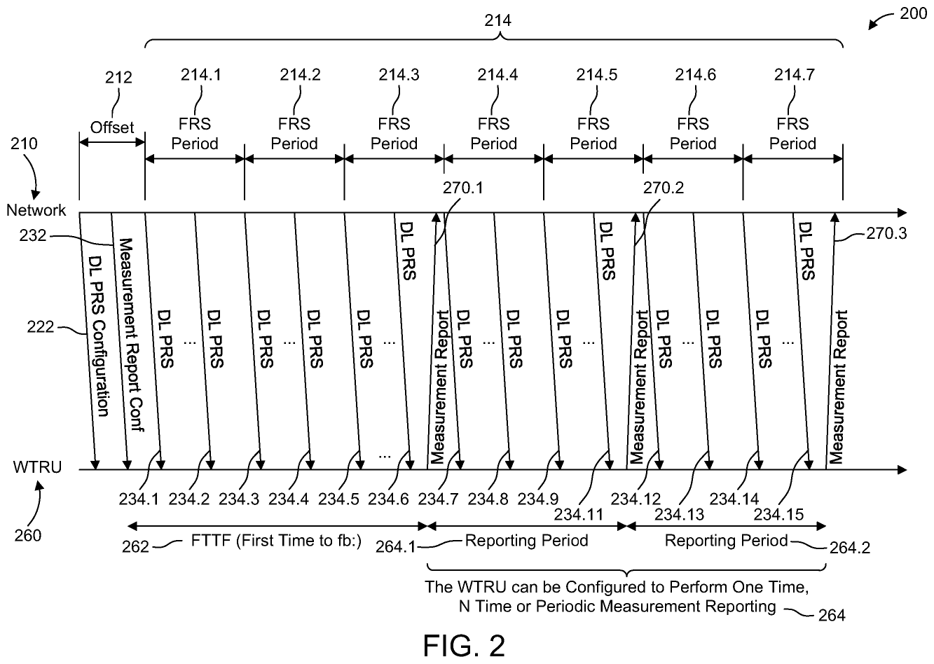

In PRS configuration and measurement reporting, for DL-based Uu positioning, the WTRU may be (pre-) configured by LMF via LPP protocol (NAS protocol) the DL PRS configuration to monitor DL PRS transmissions from gNB and measurement reporting configuration to report the positioning measurement result to the network. As shown in FIG. 2, the WTRU may receive DL-PRS configuration and reporting configuration from the network (e.g., LMF/gNB). The reporting configuration may include the First Time to Fix (FTTF) report and the periodicity of the report. The DL-PRS configuration may include the Offset and the DL-PRS periodicity.

FIG. 2 illustrates a diagram 200 of DL based PRS configuration and measurement reporting. As illustrated in FIG. 2, a WTRU 260 communicates with a network 210. An initial offset period 212 may occur where the network 210 sends DL PRS configuration information 222 and measurement report confirmation 232. After the initial offset period 212 a plurality of PRS periods 214 may occur. The plurality of PRS periods 214 may include individual PRS periods illustrated as individual PRS periods 214.1, 214.2, 214.3, 214.4, 214.5, 214.6, 214.7. During an individual PRS period 214 a series of DL PRS 234 may occur. As illustrated, PRS period 214.1 may include DL PRS 234.1 and 234.2, PRS period 214.2 may include DL PRS 234.3 and 234.4, PRS period 214.3 may include DL PRS 234.5 and 234.6, PRS period 214.4 may include DL PRS 234.7 and 234.8, PRS period 214.5 may include DL PRS 234.9 and 234.11, PRS period 214.6 may include DL PRS 234.12 and 234.13, and PRS period 214.7 may include DL PRS 234.14 and 234.15. WTRU 260 may provide a measurement report 270.1 after a FTTF 262. WTRU 260 may provide additional measurement reports 270.2, 270.3 in the illustration after reporting period 264.1 and 264.2 respectively (referred to as reporting period 264).

In sidelink positioning, there are two type of WTRUs, which are target WTRUs (i.e., the WTRU evaluating its positioning) and anchor WTRUs (i.e., the WTRU assisting the target WTRU). In term of SL-PRS configuration and positioning measurement, sidelink positioning can be divided into the following scenarios including WTRU configured-WTRU-based sidelink positioning architecture, network-configured and WTRU-based sidelink positioning, WTRU-configured and WTRU-assisted sidelink positioning, and network-configured and WTRU-assisted sidelink positioning architecture.

For sidelink positioning, anchor WTRUs (e.g., WTRUs with known position, roadside unit (RSU)) can also be used to determine the position of a WTRU (e.g., target WTRU). The relative position between the anchor WTRU and the target WTRU can be calculated based on SL-PRS measurement. The absolute position of the target WTRU can be derived based on the relative position with multiple anchor WTRUs. For in coverage scenario, it is possible that the network can use both Uu and sidelink to determine positioning of a target WTRU. For out of coverage scenario, an anchor WTRU can be used to support positioning a target WTRU. Resource provisioning for SL-PRS transmission/reception is essential to enable sidelink positioning. In resource provisioning for sidelink positioning, it is necessary to address the problem of how WTRU (e.g., target WTRU or anchor WTRU) can select/request sidelink resources and how to request other WTRU to perform SL-PRS transmission and reception to perform sidelink positioning is necessary to tackled.

The present includes solutions for ranging and positioning, LMF function, and RSU. For ranging and positioning, solutions described herein for positioning may be used for ranging without any limitation including positioning may be referred to as a method/scheme to estimate the geographical location of a WTRU, ranging may be referred to as a method/scheme to estimate the distance between WTRUs, and “positioning of a WTRU” or “location information of a WTRU” or “location estimate of a WTRU” may be interchangeably used with “a distance between WTRUs” when a solution is used for ranging.

For LMF function, an LMF is a non-limiting example of a node or entity (e.g., network node or entity) that may be used for or to support positioning. Any other node or entity may be substituted for LMF and still be consistent with this disclosure.

For RSU, RSU can be used interchangeably with WTRU. A WTRU may use one or more of the following reference signals as a SL-PRS. Such reference signals include DMRS of PSSCH and/or PSCCH, SLSS (S-PSS, S-SSS), PTRS, SL-CSI-RS, and a new RS designed for positioning purposes.

Methods for PRS scheduling are disclosed. The WTRU may request the information about sidelink positioning. In one approach, a WTRU (e.g., target WTRU) may be triggered (e.g., by upper layer) to request the information about sidelink positioning. The information may include one or more of the set of anchor WTRUs (e.g., RSU) in the area, the mapping between the anchor WTRUs and the SL-PRS resources in the resource pool, the sidelink resource pool to transmit/receive SL-PRS, and the sidelink resource pool to transmit/receive the request message for SL-PRS transmission/reception.

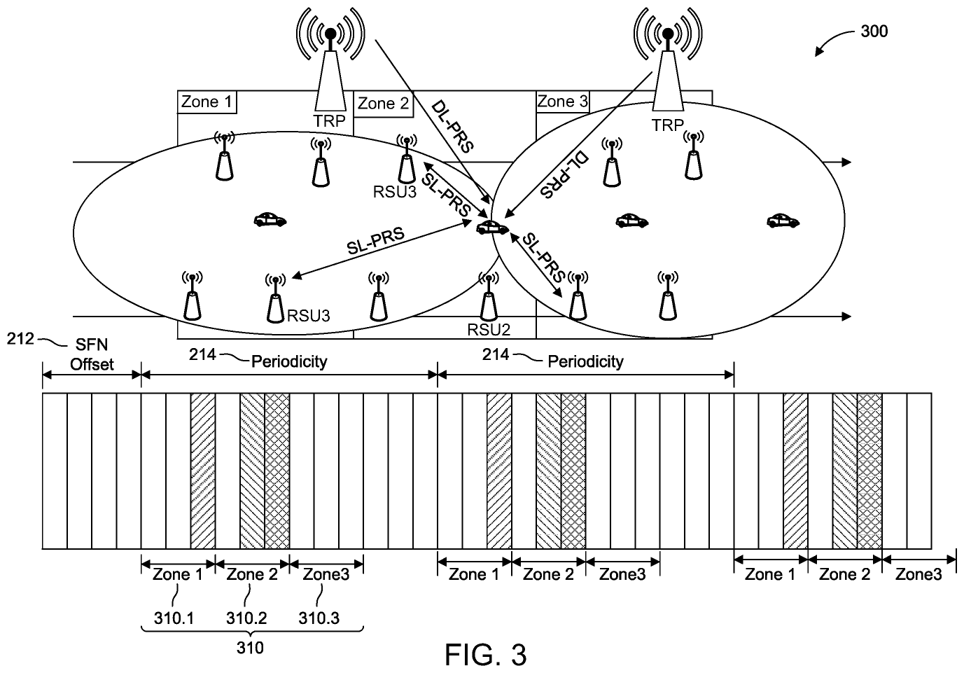

FIG. 3 illustrates SL-PRS resource pool (pre-)configuration 300. FIG. 3, in conjunction with the description of FIG. 2, illustrates zones 310 within the PRS periods 214. As provided in FIG. 3, the zones 314 may include zone 1 310.1, zone 2 310.2 and zone 3 310.3. Zones 310 may repeat in each of the PRS periods 214.

The WTRU may determine the sidelink resource to transmit SL-PRS. In one solution, a WTRU, including an anchor WTRU, may be (pre-)configured a sidelink resource pool to transmit SL-PRS. The WTRU may be (pre-)configured a mapping between the SL-PRS resource and the location of the WTRU, WTRU ID. The WTRU may determine its SL-PRS transmission resource based on its location (e.g., zone ID, which was defined in NR and LTE V2X) and/or its ID. As shown in FIG. 3, in the sidelink positioning service area, the anchor WTRUs (e.g., RSU) may be deployed along the road. Each anchor WTRU may be (pre-)configured one or multiple SL-PRS patterns in the SL-PRS resource pool. The WTRU may determine which SL-PRS resource to transmit SL-PRS based on its zone and WTRU ID. For example, in the sidelink resource pool, each zone ID may be (pre-)configured a set of SL-PRS resources. The anchor WTRU (e.g., RSU) may determine which set of resources to use based on its zone ID. In the set of resource for one zone ID, the anchor WTRU may determine which SL-PRS resource to use based on its WTRU ID. In the exemplary FIG. 3, the anchor RSU3 having WTRU ID 3 in green color (i.e., RSU3) belongs to zone ID1 can use the third SL-PRS resource configured for zone ID 1.

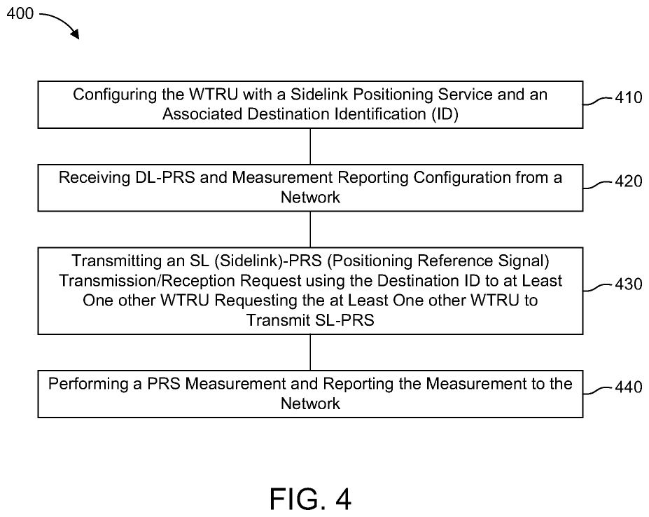

The WTRU may indicate its interest in the sidelink positioning service. FIG. 4 illustrates a method 400 configured for a WTRU in the sidelink positioning service. The WTRU may indicate to the network the interest in sidelink positioning service. Specifically, in method 400, the WTRU may transmit one message to the network (e.g., NAS or RRC message) to indicate its interest in the sidelink positioning service. The WTRU may then implicitly/explicitly indicate an identity (e.g., destination ID) associated with the sidelink positioning service to the network. The WTRU may then use the associated destination to communicate with the network regarding the sidelink positioning service. Specifically, the WTRU may then use the destination to request the SL-PRS transmission/reception resources and perform sidelink measurement reporting.

In method 400, the WTRU may be configured with a sidelink positioning service and an associated destination ID at 410. At 420, the WTRU may receive DL-PRS and measurement reporting configuration from a network. At 430, the WTRU may transmit an SL-PRS transmission/reception request using the destination ID to at least one other WTRU requesting the at least one WTRU to transmit SL-PRS. The request may include at least one parameter based on the received measurement reporting configuration and QoS of a positioning service. The at least one parameter may include at least one of validity time, type of SL-PRS transmission request; set of anchor WTRUs, a set of SL-PRS resources, a requested SL-PRS pattern, and priority of a request message. The transmitting may be based on at least one of the DL-PRS configuration, result of the DL-PRS measurement, and SL-PRS measurement. The transmitting may include one of broadcasting and group casting using the associated destination ID. At 440, the WTRU may perform a PRS measurement and report the measurement to the network. The performing a PRS measurement may include one of a SL-PRS and a DL (downlink)-PRS.

The WTRU may obtain the sidelink positioning configuration information. The WTRU may obtain the sidelink positioning configuration information by one or more of (pre-)configuration, by the network via SIB or RRC message, and by other WTRU, including the anchor WTRU.

The WTRU may determine to obtain the sidelink positioning configuration information based on one or more of the coverage status of the WTRU (e.g., whether the WTRU is in coverage or out of coverage). In one approach, the WTRU may use (pre-)configuration to obtain the sidelink positioning configuration if it is out of coverage. Alternatively, it may obtain the sidelink positioning configuration from another WTRU (e.g., anchor WTRU).

The WTRU may determine to obtain the sidelink positioning configuration information based on the RRC status of the WTRU. For example, the WTRU may obtain the sidelink positioning configuration information via RRC message if it is in RRC CONNECTED. The WTRU may obtain the sidelink positioning configuration information via SIB if it is in RRC IDLE/INACTIVE.

The WTRU may receive SL-PRS scheduling for a group of WTRUs. In one method, a WTRU, including a target WTRU, may receive SL-PRS pattern configuration for a group of WTRU(s) (e.g., target WTRU and anchor WTRUs. The WTRU may then forward SL-PRS pattern configuration to the WTRU(s) in the group. The WTRU may indicate an ID (e.g., destination ID) associated with the positioning group/service in the forward message. The ID may be generated by the upper layer or provided by the network.

The WTRU requests the resource for SL-PRS transmission/reception. In one solution, the WTRU may request SL-PRS transmission/reception resource. In one approach, the WTRU may use MAC CE (e.g., Sidelink Buffer Status Report (SL BSR)) to request the SL-PRS transmission/reception resource. In another approach, the WTRU may use RRC or NAS message to request the resource for SL-PRS transmission/reception. The WTRU may use the dedicated destination ID and/or destination index associated with the sidelink positioning service to request the SL-PRS resource from the network. The WTRU may determine to request the SL-PRS resource for its SL-PRS transmission. The WTRU request the SL-PRS resource for other WTRU transmissions.

The WTRU may forward the scheduled SL-PRS transmission/reception resource to other WTRUs. The WTRU, upon reception of the SL-PRS transmission/reception resources from the network, may forward the resources to the WTRU in the positioning group. The WTRU may indicate the transmission and/or reception WTRUs for each resource.

Methods for SL-PRS request and transmission are described. The WTRU may determine the parameters in the request message. In one method, a WTRU, such as a target WTRU, may request other nodes (e.g., anchor WTRU, RSU) to transmit/receive SL-PRS. The WTRU may implicitly/explicitly indicate one or any combination of the following parameters regarding SL-PRS transmission/reception and the associated measurement report in the request message. The parameters may include a type of the request message. For example, the WTRU may request another node to transmit, receive SL-PRS or both transmit and receive SL-PRS. The parameters may include the SL-PRS pattern. For example, the SL-PRS pattern which may be determined based on one or more of the type of the SL-PRS transmission (e.g., periodic, or aperiodic SL-PRS transmission/reception), the offset, periodicity, and/or the number of repetitions for the SL-PRS transmission, the bandwidth, frequency density, and/or time density of the SL-PRS, the transmission power of the SL-PRS, the priority level of the SL-PRS, the set of anchor WTRUs and/or the set of SL-PRS resources. For example, the WTRU may indicate the set of anchor WTRUs to transmit SL-PRS, the set of anchor WTRUs to receive SL-PRS, and/or the set of anchor WTRUs to transmit and receive SL-PRS. The parameters may include the ID associated with the set of anchor WTRUs. For example, the WTRU may indicate in the request message an ID associated with the set of anchor WTRUs. The WTRU may be (pre-)configured two IDs, in which one ID may be used when the WTRU is not aware of the set of anchor WTRUs and another ID may be used when the WTRU is aware of the set of anchor WTRUs.

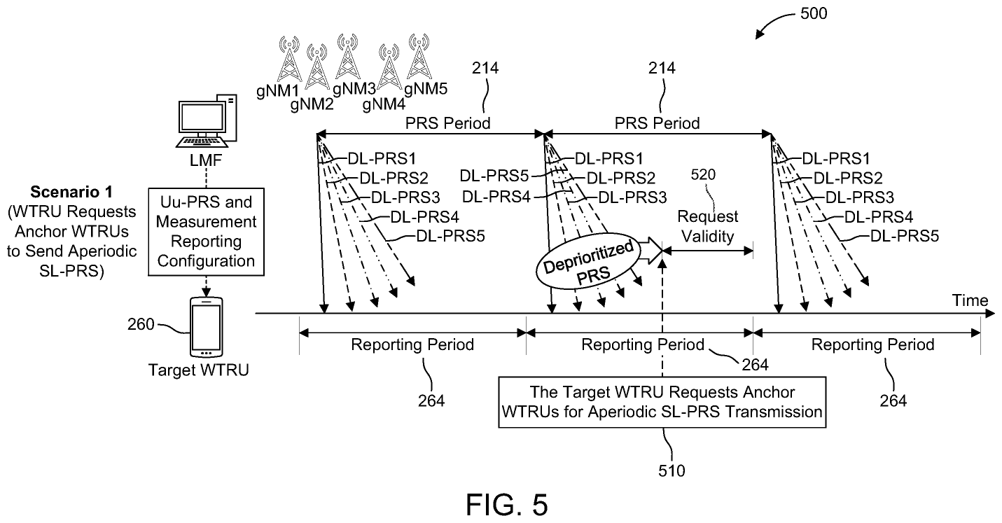

In a first scenario depicted in FIG. 5, a WTRU 260 may request an anchor WTRU(s) to send aperiodic SL-PRS. FIG. 5 depicts a diagram 500 of DL based Uu-PRS and measurement reporting configuration. As illustrated in FIG. 5, with reference to FIG. 2, diagram 500 depicts the WTRU 260 with a series of PRS periods 214 and reporting periods 264. As illustrated in FIG. 5, the target WTRU 260 requests 510 an anchor WTRU(s) for aperiodic SL-PRS transmission. In a PRS period 214, a plurality of DL-PRS are deprioritized during a reporting period 264. Once the request 510 is provided, the target WTRU 260 may provide a request validity 520, which may require the anchor WTRU(s) to provide the SL-PRS transmission within the request validity time, which may happen before the end of the current reporting period 264.

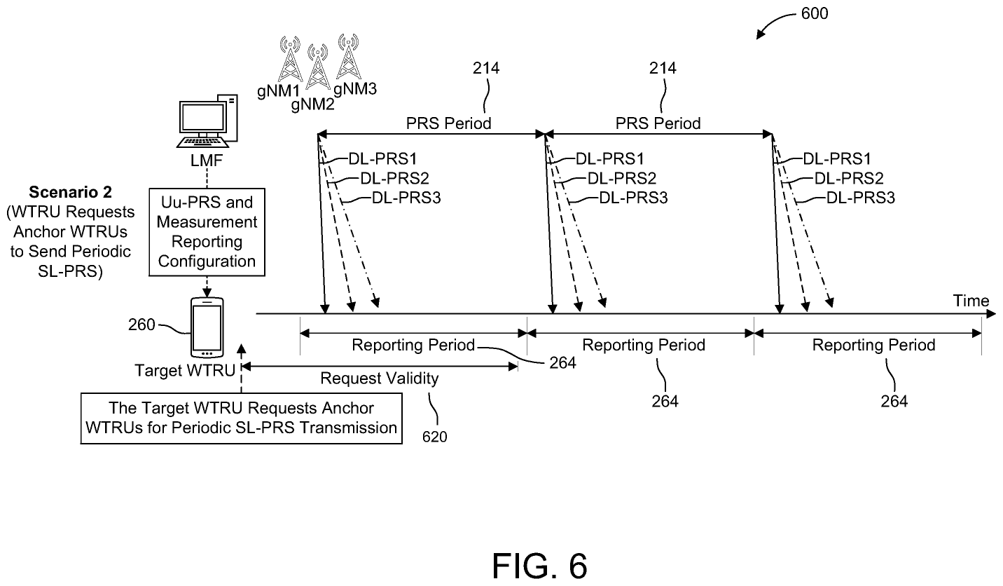

In a second scenario depicted in FIG. 6, a WTRU 260 may request an anchor WTRU(s) to send periodic SL-PRS. FIG. 6 depicts a diagram 600 of DL based Uu-PRS and measurement reporting configuration. As illustrated in FIG. 6, with reference to FIG. 2, diagram 600 depicts the WTRU 260 with a series of PRS periods 214 and reporting periods 264. As shown in FIG. 6, the target WTRU receive DL based Uu-PRS configuration, which consist of 3 DL-PRSs per DL-PRS period, which may correspond to 3 TRPs. As illustrated in FIG. 6, the target WTRU 260 then requests 610 an anchor WTRU(s) for periodic SL-PRS transmission. In a PRS period 214, a plurality of DL-PRS are provided during a reporting period 264. Once the request 610, the target WTRU 260 may provide a request validity 620, which may require the anchor WTRU(s) to provide the first SL-PRS transmission within the request validity time, which may happen before the end of the current reporting period 264.

The parameters may include the validity of the request message. For example, the validity of the request message may indicate the window in which the WTRU is expected to receive the response message. The response message may be an SL-PRS transmission and/or the measurement reporting. In one example, the WTRU may request another node to transmit SL-PRS. The WTRU may indicate the maximum latency to receive SL-PRS from the anchor WTRU. The WTRU may decode the SL-PRS if it is transmitted within the latency requirement. Alternatively, the WTRU may discard the transmission.

In another example, the WTRU may request another node to receive SL-PRS and perform measurement reporting. The WTRU may indicate the reception window in the request message. The anchor WTRU may perform SL-PRS decoding in the indicated reception window.

The parameters may include the priority of the request message and/or the expected range of the measurement result. In one example, the WTRU may indicate the expected range of the measurement result (e.g., expected RSTD and the error bound). In another example, the WTRU may indicate its location and the expected error bound (e.g., zone ID).

The WTRU sends the request message to other WTRU for SL-PRS transmission/reception. In one approach, a WTRU (e.g., target WTRU) may determine to request another node (e.g., anchor WTRUs, gNB) to transmit and/or receive SL-PRS. The WTRU may determine whether to request another node (e.g., another WTRU) to transmit/receive SL-PRS and/or perform sidelink positioning measurement reporting. For example, the following may be used alone or in any combination. These include indication from the network, the number of PRS resources, beams, and/or TRPs the WTRU performs measurement in a period, the number of measured beams/TRPs having RSRP being greater than a threshold, the number of measured beams/TRPs having LOS/NLOS being greater than a threshold, whether the WTRU performs Uu PRS measurement in a certain number of DL-PRS transmission and/or reception, whether the WTRU performs UL PRS transmission in a certain number of UL PRS resources, and whether the current PRS configuration and/or PRS measurement satisfies the QoS requirements of the positioning service.

In one solution, the WTRU may request another node (e.g., another WTRU) to transmit/receive SL-PRS and/or perform sidelink positioning measurement reporting based on the indication from the network. Specifically, the network (e.g., LMF) may request the WTRU to request another WTRU to participate in the positioning service. The WTRU may then request other WTRUs to perform SL-PRS transmission/reception and/or sidelink positioning measurement reporting.

In another solution, the WTRU may determine whether to request another node (e.g., another WTRU) to transmit/receive SL-PRS and/or perform sidelink positioning measurement reporting based on the number of PRS resources, beams, and/or TRPs the WTRU measured in a period. Specifically, the WTRU may request another WTRU to transmit/receive SL-PRS and/or perform sidelink positioning measurement reporting if the number of measured PRS resources, beams, and/or TRPs is smaller than a threshold. The WTRU may receive the threshold from the network (e.g., LMF). The period may be determined based on the positioning measurement reporting configuration. For example, the WTRU may determine to request another WTRU to perform SL-PRS transmission/reception and/or measurement reporting if the number of measured TRPs between two positioning report occasion is smaller than four. Otherwise, if the number of measured TRPs between two positioning report occasion is greater than four, the WTRU may not request another WTRU to perform SL-PRS transmission/reception and/or measurement reporting.

In another solution, the WTRU may determine whether to request another node (e.g., another WTRU) to transmit/receive SL-PRS and/or perform sidelink positioning measurement reporting based on the number of measured beam/TRPs having RSRP being greater than a threshold. Specifically, the WTRU may request another node (e.g., another WTRU) to transmit/receive SL-PRS and/or perform sidelink positioning measurement reporting if it there are less than four beam/TRPs having RSRP being greater than threshold. Otherwise, the WTRU may not request another node to perform SL-PRS transmission/reception and/or sidelink positioning measurement report.

In another solution, the WTRU may determine whether to request another node (e.g., another WTRU) to transmit/receive SL-PRS and/or perform sidelink positioning measurement reporting based on the number of measured beam/TRPs having LOS/NLOS value being within a range. Specifically, the WTRU may request another node (e.g., another WTRU) to transmit/receive SL-PRS and/or perform sidelink positioning measurement reporting if there are less than four beam/TRPs having LOS/NLOS value being within a range. Otherwise, the WTRU may not request another node to perform SL-PRS transmission/reception and/or sidelink positioning measurement report.

In another solution, the WTRU may request another node (e.g., another WTRU) to transmit/receive SL-PRS and/or perform sidelink positioning measurement reporting if it does not perform Uu PRS measurement in a certain number of resource, beams and/or TRPs. Specifically, the WTRU may deprioritize DL-PRS reception of one or more DL-PRs resources. The WTRU may then determine to request another node (e.g., another WTRU) to transmit/receive SL-PRS and/or perform sidelink positioning measurement reporting

In another solution, the WTRU may request another node (e.g., another WTRU) to transmit/receive SL-PRS and/or perform sidelink positioning measurement reporting if it does not perform UL PRS transmission in one or more configured SRS resources. The WTRU may not perform UL PRS resource in one or more configured SRS resource due to the SRS resource is deprioritized.

In another solution, a WTRU including the target WTRU may determine whether to request other nodes including the anchor WTRU or RSU to transmit/receive SL-PRS based on whether the current PRS transmission/reception satisfies the required QoS of the positioning service. For example, the WTRU may require another node to transmit/receive SL-PRS if the current PRS transmission/reception of the WTRU cannot satisfy the QoS of the positioning service. Otherwise, the WTRU may not require another node to transmit/receive SL-PRS.

The WTRU may request other nodes to transmit/receive SL-PRS, triggers SL-PRS transmission, and implicitly/explicitly indicate one or multiple parameters. One parameter may include an indication from the network. For example, the WTRU may determine whether to request other WTRU to transmit/receive SL-PRS, and/or triggers SL-PRS transmission based on the indication from the network. In one example, the network (e.g., LMF) may request the WTRU to report sidelink positioning measurement to support the network in determining the position of the WTRU. The WTRU may then request other WTRU, including an anchor WTRU, to transmit/receive SL-PRS, and/or triggers SL-PRS transmission for its sidelink positioning measurement.

One parameter may include the configured positioning method. For example, the WTRU may determine the parameters in the request message based on the configured positioning method. In one example, the WTRU may request other WTRU to transmit SL-PRS if it is configured to perform DL-based positioning in Uu interface. For example, if the WTRU is configured to receive DL-PRS, the WTRU may request other WTRU to transmit SL-PRS. Alternatively, the WTRU may request other WTRU to receive SL-PRS, and/or triggers SL-PRS transmission if it is configured to perform UL-based positioning in Uu interface. The WTRU may request other WTRU to receive SL-PRS if it is configured to transmit UL-PRS. Finally, the WTRU may request other WTRU to transmit and receive SL-PRS if the WTRU is configured to perform DL and UL based positioning in Uu interface including the RTT method.

One parameter may include the PRS configuration of the WTRU, which may include the PRS transmission/reception configuration and measurement reporting configuration. The WTRU may receive DL-PRS, UL-PRS and both DL-PRS, and UL-PRS configurations from the network. The WTRU may determine whether to request other WTRUs, including an anchor WTRU and RSU, to transmit/receive SL-PRS, triggers SL-PRS transmission, and/or set the parameters in the request message based on the received PRS configuration from the network.

The PRS configuration may include one or more of the offset of the DL-PRS and/or UL-PRS, the number of repetitions, the periodicity of the DL-PRS and/or UL-PRS, muting pattern for DL-PRS and transmission power. In one example, the WTRU may determine whether to request other WTRU to transmit/receive SL-PRS, and/or triggers SL-PRS transmission based on the number of configured TRPs for DL-PRS reception. If the number of configured TRPs is greater than a threshold, the WTRU may determine not to request another node to transmit/receive SL-PRS and the WTRU may not trigger SL-PRS transmission. Otherwise, if the number of TRPs is smaller than a threshold, the WTRU may request another node to transmit/receive SL-PRS, and/or triggers SL-PRS transmission. The threshold may be (pre-)configured or configured by the gNB/LMF.

In another example, the WTRU may determine whether to request other WTRU to transmit/receive SL-PRS, and/or triggers SL-PRS transmission based on the periodicity of DL-PRS. Specifically, if the periodicity of DL-PRS satisfies a condition (e.g., smaller, or larger than a threshold), the WTRU may request other WTRU to transmit/receive SL-PRS, and/or triggers SL-PRS transmission. Otherwise, the WTRU may not request other WTRU to transmit/receive SL-PRS and may not trigger SL-PRS transmission. Alternatively, the WTRU may determine whether to request other WTRU to transmit/request SL-PRS, and/or triggers SL-PRS transmission based on the number of repetitions of DL-PRS in one period. Specifically, the WTRU may request other WTRU to transmit/receive SL-PRs, and/or triggers SL-PRS transmission if the number of repetitions is smaller than a threshold. Otherwise, the WTRU may not request other WTRU to transmit/receive SL-PRS. The threshold may be (pre-)configured or configured by the gNB/LMF.

In another example, the WTRU may determine whether to transmit SL-PRS and/or request other WTRU to receive SL-PRS based on the UL-PRS configuration. Specifically, the WTRU may determine to transmit SL-PRS and/or request other WTRU to receive its SL-PRS based on the transmission power of UL-PRS. If the transmission power of UL-PRS satisfies a condition (e.g., smaller, or larger than a threshold), the WTRU may transmit SL-PRS and/or request other WTRU to receive its SL-PRS. Otherwise, the WTRU may not request other WTRU to receive SL-PRS. The threshold may be (pre-)configured or configured by the gNB/LMF.

One parameter may include the measurement reporting configuration. The WTRU may receive positioning measurement reporting configuration from the network. The configuration may include one or more of the type of report (e.g., periodic report or aperiodic report), the offset and periodicity of the report, the number of measurements in one report period (e.g., the number of resources, beams, TRP, etc., in on report period). In one example, the WTRU may determine whether to request other WTRU to transmit/receive SL-PRS, and/or triggers SL-PRS transmission based on the periodicity or type of the measurement report. For example, the WTRU may request other WTRU to transmit/receive SL-PRS, and/or triggers SL-PRS transmission if the priority of the positioning measurement report satisfies a condition (e.g., larger/smaller than a threshold). The threshold may be (pre-)configured or configured by the gNB/LMF.

In another example, the WTRU may determine whether to request other WTRU to transmit/receive SL-PRS, and/or triggers SL-PRS transmission based on the number of requested measurements in a period. For example, if the number of requested measurements is greater than a threshold, the WTRU may request other WTRU to transmit/receive SL-PRS. Otherwise, the WTRU may not request other WTRU to transmit/receive SL-PRS. The threshold may be (pre-)configured or configured by the gNB/LMF.

The set of detected anchor WTRUs and/or the SL-PRS transmission pattern. Specifically, the WTRU may be configured by gNB/LMF or (pre-)configured to perform SL-PRS detection in a SL-PRS resource pool. The WTRU may then determine whether to request other WTRU to transmit/receive SL-PRS, and/or triggers SL-PRS transmission based on the set of the detected anchor WTRUs in the resource pool.

In one example, the WTRU may detect SL-PRS transmission in a set of (pre-)configured resources. The WTRU may then request other WTRUs to transmit SL-PRS if SL-PRS transmission is not detected in the (pre-)configured resource. The WTRU may request all the anchor WTRUs in the (pre-)configured SL-PRS resources to transmit SL-PRS. Alternatively, it may request a subset of WTRUs to perform SL-PRS transmission. The subset of anchor WTRUs may be determined based on other criteria such as the QoS of the positioning service, the number of TRPs configured for DL-PRS reception.

The availability of anchor WTRU in the area. For example, the WTRU may determine to request one or multiple anchor WTRUs to transmit/receive SL-PRS, and/or triggers SL-PRS transmission based on the availability of the anchor WTRUs in the area. For example, the network, including LMF/gNB, may indicate the availability of the RSU in the area. The WTRU may request the anchor WTRU to transmit/receive SL-PRS. In one approach, the WTRU may detect SL-PRS transmission in the (pre-)configured sidelink resource pool. If one or multiple SL-PRS transmission is not detected, the WTRU may request the anchor WTRUs to perform SL-PRS transmission. In another approach, the WTRU may request the anchor WTRUs to transmit/receive SL-PRS regardless of the availability of SL-PRS transmission of the anchor WTRUs in the (pre-)configured sidelink resource pool.

The (pre-)configured SL-PRS pattern for anchor WTRUs. Specifically, an anchor WTRU may be (pre-)configured a SL-PRS pattern to transmit. A WTRU, including the, target WTRU, may determine whether to request the anchor WTRU to change the SL-PRS pattern based on the QoS of the positioning service. For example, the WTRU may request the anchor WTRU to change one or any combination of the following parameters of the SL-PRS pattern: The offset of the SL-PRS; the number of repetitions; the priority of the SL-PRS; and the transmission power.

In one example, the anchor WTRU may be (pre-)configured multiple SL-PRS patterns. The WTRU may then determine its preferred SL-PRS transmission pattern and request the anchor WTRU to change to the preferred SL-PRS transmission pattern.

One parameter may include the result of DL-PRS measurement. The WTRU may determine whether request other WTRU to transmit/receive SL-PRS, and/or triggers SL-PRS transmission based on the result of DL-PRS measurement. For example, the WTRU may request other WTRU to transmit/receive SL-PRS based on one or more triggers. The triggers include RSRP of DL-PRS is smaller than a threshold. For example, the WTRU may request other WTRU to transmit/receive SL-PRS, and/or triggers SL-PRS transmission if RSRP measured in one of multiple DL-PRS resources is smaller than a threshold. The threshold may be configured by LMF/gNB.

The triggers may include one or multiple DL-PRS receptions are deprioritized, NLOS is detected for one or multiple TRPs and the transmission activity of UL-PRS. For example, the WTRU may determine whether to request other WTRU to transmit/receive SL-PRS, and/or triggers SL-PRS transmission based on the UL-PRS transmission of the WTRU. For example, if the UL-PRS is deprioritized or UL-PRS Tx power of the WTRU is smaller than a threshold, the WTRU may request other WTRU to transmit/receive SL-PRS, which may be used to support the network in obtaining another PRS measurement in PC5 interface. The threshold may be configured by LMF/gNB.

The WTRU may determine which type of message to request SL-PRS transmission/reception. In one approach, the WTRU may use one or any combination of the following message/signal to request other WTRU, including the anchor WTRU, to transmit/receive SL-PRS:

The triggers may include a sequence and/or a SL-PRS transmission. In one example, the WTRU may be (pre-) configured by the network, including an LMF/gNB, one or multiple sequences to request other nodes to transmit/receive SL-PRS. In one approach, the target and anchor WTRUs may be (pre-)configured sidelink resources to transmit/receive the request message. The WTRU then may use the (pre-)configured resources to transmit/receive the request message. In another example, the WTRU may transmit SL-PRS to request other WTRU to transmit SL-PRS. For example, the target and anchor WTRUs may be (pre-)configured one sidelink positioning method, which may require each WTRU, including the target WTRU and anchor WTRU, to perform both SL-PRS transmission and reception (e.g., the RTT-based method). The WTRU may request other WTRU to transmit SL-PRS by transmitting SL-PRS. In one approach, the requested SL-PRS pattern may be indicated in an SCI associated with the transmitted SL-PRS. In another approach, the requested SL-PRS pattern may be exchanged between the WTRUs before the request message (e.g., via PC5 RRC among WTRUs or configured by the network (e.g., LMF/gNB).

The triggers may include a unicast message. The WTRU may use the existing unicast link to request other WTRU to transmit/receive SL-PRS. For example, if the WTRU already has established a PC5 RRC to an anchor WTRU, the WTRU may request the anchor WTRU to transmit/receive SL-PRS. The WTRU may use the (pre-)configured sidelink resource pool for data transmission/reception to transmit the request message. The request message may be multiplexed with the normal sidelink data. The WTRU may use PC5 RRC, MAC CE and/or SCI to convey the parameters associated with the SL-PRS transmission/reception.

The triggers may include a groupcast/broadcast message. The WTRU may use groupcast/broadcast message to send the request message to one or multiple WTRUs. For example, a WTRU, including a target WTRU, may be (pre-)configured by upper layer or by the network (e.g., gNB/LMF) one ID (e.g., destination ID) to send/receive SL-PRS transmission/reception request message. The WTRU may be (pre-)configured a sidelink resource pool to send/receive a request message. When the WTRU requests SL-PRS transmission/reception, the WTRU may indicate the (pre-)configured destination ID in the message (e.g., in the second SCI) and using the (pre-)configured sidelink resource pool. Other WTRUs, including an anchor WTRU, involving in the sidelink positioning service may monitor the sidelink resource pool and use the destination ID to detect any request message.

The WTRU may determine which positioning method to use. A WTRU, including a target WTRU, may use one or more sidelink positioning methods. One sidelink positioning method includes SL-PRS transmission-based. For example, for this method, the target WTRU may perform SL-PRS transmission. The anchor WTRU may perform SL-PRS reception and report the sidelink positioning measurement.

One sidelink positioning method includes SL-PRS reception-based. For example, for this method, the anchor WTRUs may perform SL-PRS transmission. The target WTRU may perform SL-PRS reception from all anchor WTRUs. The WTRU may then calculate its position and/or report the positioning measurement to another node (e.g., LMF/gNB or RSU).

One sidelink positioning method includes SL-PRS transmission and reception-based. For example, for this method, the anchor and target WTRUs may perform both SL-PRS transmission and reception.

One sidelink positioning method includes anchor-WTRU-based method. For example, for this method, one set of anchor WTRU may perform SL-PRS transmission, another set of anchor WTRU may perform SL-PRS reception, and another set of anchor WTRU may perform both SL-PRS transmission and reception.

A WTRU may determine which positioning method to use. The WTRU may base this decision on the coverage status of the target WTRU and anchor WTRUs. For example, the WTRU may determine which positioning method to use based on the coverage status of the target WTRU and the anchor WTRU. The coverage status of the anchor WTRUs may belong to one or any combination of the following: All WTRUs are in one network coverage; all WTRUs are out of network coverage; one set of WTRUs are in network coverage and another set of WTRU are out of network coverage. The WTRU may be configured by the network (e.g., gNB/LMF) or (pre-)configured, for each coverage status of target and anchor WTRUs, a set of positioning methods to be used. The WTRU may then determine which positioning method to use based on the coverage status of the target WTRU and anchor WTRUs and the associated configured positioning method. In one example, the WTRU may determine to use the anchor-WTRU-based method if one set of anchor WTRU is in coverage and another set of anchor WTRU is out of coverage. For this method, the WTRU may request the in-coverage anchor WTRU to either transmit or receive SL-PRS. In another example, the WTRU may determine to use the methods requiring loose synchronization (e.g., AoA, AoD, multi-RTT) if one set of the anchor WTRUs is out of network coverage. The WTRU may determine to use the methods requiring tight synchronization (e.g., TDOA) if all WTRU is in the network coverage.

The WTRU may base this decision on the positioning method in Uu. For example, the WTRU may determine the sidelink positioning method based on the configured positioning method in Uu. In one example, the WTRU may use SL-PRS transmission-based method if the network (e.g., LMF) configures the WTRU to perform UL-based method in Uu. If the WTRU is configured to transmit SRS only, the WTRU may determine to transmit SL-PRS to the anchor WTRUs. In another example, the WTRU may use SL-PRS reception-based method if the network (e.g., LMF) configures the WTRU to perform DL-based method in Uu. If the WTRU is configured to receive DL-PRS only, the WTRU may determine to receive SL-PRS from the anchor WTRUs. In another example, the WTRU may use SL-PRS transmission-based method if the network (e.g., LMF) configures the WTRU to perform DL+UL-based method in Uu (e.g., multi-RTT method). If the WTRU is configured to transmit SRS and receive DL-PRS, the WTRU may determine to transmit and receive SL-PRS from all anchor WTRUs.

The WTRU may switch between two positioning methods. In one method, the WTRU may determine to switch between different sidelink positioning methods based on the change in coverage status of the set of anchor WTRUs. For example, the WTRU may switch from one positioning method to another position method if the coverage status of the set of anchor WTRUs is changed. The coverage status of the set of anchor WTRUs may be changed due to one or any combination of the following: out of coverage WTRUs are added to the set of anchor WTRUs; an anchor WTRU changes from in coverage status to out of coverage; the out of coverage WTRUs are removed from the set of anchor WTRUs.

In one example, the WTRU may switch from SL-PRS transmission or SL-PRS reception-based method to SL-PRS transmission and reception-based or anchor-WTRU-based method if out of coverage WTRUs are added to the set of anchor WTRUs or one anchor WTRU changes from in coverage status to out of coverage. Alternatively, the WTRU may switch from SL-PRS transmission and reception-based or anchor-WTRU-based method to L-PRS transmission or SL-PRS reception-based method if the out of coverage WTRUs are removed from the set of anchor WTRUs.

Methods for PRS measurement and report are also described. The WTRU may perform SL-PRS measurement. In one method, a WTRU (e.g., target WTRU) may perform SL-PRS measurement in a (pre-) configured SL-PRS resource to detect SL-PRS transmission of other WTRU (e.g., anchor WTRU). The WTRU may then determine the availability of SL-PRS transmission in each (pre-)configured SL-PRS reception resource.

In one method, the WTRU determines the WTRU transmitting SL-PRS. The WTRU may determine the WTRU ID transmitting SL-PRS in a SL-PRS resource pool based on one or more features. These features include the characteristics of the detected SL-PRS (resource, signals/sequence index), the zone ID associated with the detected SL-PRS resource, and the SL-PRS resource pool configuration.

The anchor WTRU (e.g., RSU) may be (pre-)configured to transmit SL-PRS based on its zone ID and WTRU ID. A set of sequence ID may be (pre-)configured in the resource pool. The anchor WTRU may determine which sequence ID to use based on the WTRU ID, resource ID, and/or the zone ID. The target WTRU may determine which anchor WTRU transmitting SL-PRS in a (pre-)configured resource based on the detected signal/sequence, zone ID associated with the detected SL-PRS resource and/or the SL-PRS resource pool configuration.

In a method, the WTRU determines which information to include in the measurement reporting message. In one method, the WTRU may send measurement report to the network (e.g., gNB or LMF) and/or one or multiple anchor WTRUs. The WTRU may include one or more positioning measurements in a measurement report message. This positioning measurement may include DL-PRS measurement from multiple TRPs, SL-PRS measurement from in coverage anchor WTRUs, and SL-PRS measurement from out of coverage anchor WTRUs. The PRS (e.g., DL-PRS or SL-PRS) measurement may include one or more of RSTD, the time gap between PRS transmission and reception, AoA, AoD, ToA, TOD, SL-RSRP, SL-RSRQ, SL-RSSI, LOS/NLOS status, D-RSRP, DL-RSRQ, DL-RSSI, etc., time stamp or indication of when including slot number, symbol number, frame number) the measurements on DL-PRS and/or SL-PRS are made, time stamp or indication of when the measurements are made may be based on a global reference of time or local reference of time.

In one method, the WTRU may report the measurement to the network including gNB/LMF. In one approach, the WTRU may report the SL-PRS measurement from both in coverage anchor WTRUs and out of coverage anchor WTRUs. The WTRU may include the information of the out of coverage anchor WTRU such as the WTRU ID, the resource ID, etc. In another approach, the WTRU may report the SL-PRS measurement from the in-coverage anchor WTRUs. The WTRU may first determine which anchor WTRU is in network coverage. The WTRU may select the in SL-PRS measurement from the in-coverage anchor WTRUs and report to the network. The WTRU may discard the SL-PRS measurement from out of coverage anchor WTRUs in the measurement report. The aforementioned measurements include time and/or angle of arrival of DL-PRS and/or SL-PRS.

In another method, the WTRU may perform measurement report to both gNB and anchor WTRU. The anchor WTRU may be out of network coverage. The WTRU may transmit assistance information including DL-PRS configuration and location of the gNB to support the anchor WTRU in determining the position of the WTRU.

The WTRU may determine which node to report the message. In one method, the WTRU may determine which anchor WTRU to perform measurement reporting based on the coverage status of the anchor WTRU and the configured positioning method. In one example, the WTRU may determine to report the positioning measurement to an in-coverage anchor WTRU including RRC_CONNECTED anchor WTRU if the WTRU is (pre-)configured to report the positioning measurement to the network. The WTRU may report the positioning measurement made on out of coverage anchor WTRUs and/or out of coverage SL-PRS, and/or (pre-)configured SL-PRS for the in-coverage anchor WTRU when it detects an in-coverage anchor WTRU. This approach may be motivated to switch its positioning method from offline to online.

The WTRU may perform periodic measurement reporting. In one method, a WTRU including an anchor WTRU or target WTRU may perform positioning measurement reporting. The WTRU may determine the periodicity and offset of the measurement reporting. This determination may be based on the QoS of the positioning service. For example, the WTRU may use the first reporting periodicity including short periodicity for low latency positioning service and may use the second reporting periodicity including longer periodicity for delay-tolerance service.

The determination may be based on the SL-PRS pattern. For example, the WTRU may determine the reporting periodicity based on the received SL-PRS pattern. Specifically, the WTRU may determine to perform reporting after a certain number of SL-PRS receptions in one or multiple SL-PRS periods. The number of SL-PRS receptions may be determined based on the QoS requirement of the positioning service including accuracy requirement.

The WTRU may perform aperiodic measurement reporting. In a method, the WTRU may perform event-triggered reporting. The WTRU may perform positioning measurement reporting based on one or more events including the reception of one or multiple SL-PRS. For example, the WTRU may trigger SL-PRS measurement reporting based on the reception of one or multiple SL-PRSs.

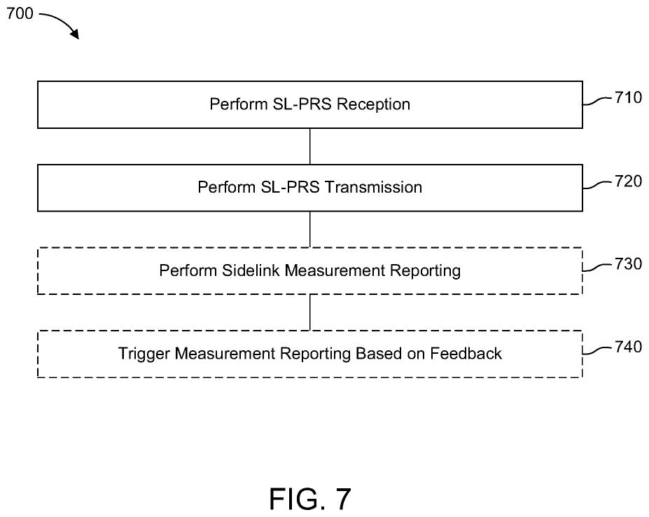

FIG. 7 illustrates a method 700 of measurement reporting. For example, for multi-RTT method, the WTRU (e.g., anchor WTRU) may first perform SL-PRS reception at 710. The WTRU may then perform SL-PRS transmission upon successfully receive SL-PRS from the peer WTRU at 720. The WTRU may then perform sidelink measurement reporting (e.g., Rx-Tx time) upon successfully transmit SL-PRS to the peer WTRU at 730. Alternatively, the WTRU may trigger measurement reporting upon successfully receive ACK feedback from the peer WTRU for the SL-PRS transmission at 740. For example, the WTRU may be (pre-) configured to perform sidelink positioning measurement reporting after performing minimum and/or maximum number of SL-PRS. The WTRU may then trigger sidelink positioning measurement reporting if the number the measured SL-PRS satisfies the (pre-)configured threshold(s).

The positioning measurement reporting may be based on the SL-PRS measurement satisfies a (pre-) defined condition. For example, the WTRU may be (pre-)configured to perform SL-PRS based on pre-defined or (pre-)configured conditions. Otherwise, the WTRU may not need to perform SL-PRS measurement. The (pre-)configured condition may be conveyed to the WTRU via PC5 RRC or from gNB/LMF. This approach may be motivated to reduce the SL-PRS measurement reporting. The (pre-)defined or (pre-)configured condition may include one or more of SL-RSRP measured in SL-PRS is greater than a threshold, LOS/NLOS is detected, and SL-PRS measurement is within an expected range, such as the RSTD falls within the ranged indicated by the other WTRU including the target WTRU.

The WTRU may determine the resource selection window for the transmissions of sidelink measurement reporting. The WTRU may determine the resource selection window for sidelink positioning measurement reporting. The resource selection window for one TB may be used to describe the minimum resource selection window, maximum resource selection window, or the actual resource selection window. The WTRU may select a long resource selection window if the latency requirement of the sidelink positioning measurement reporting is large; otherwise, if the latency requirement of the sidelink positioning measurement reporting is small, the WTRU may select a short resource selection window for the sidelink positioning measurement reporting. The resource selection window may be determined based on one or more of a configuration or pre-configuration, the SL-PRS pattern, the QoS of the positioning service, indication by another node including the target WTRU or gNB, and measurement reporting configuration.

For example, the WTRU may be (pre-)configured a maximum latency of sidelink positioning measurement reporting. The WTRU may then determine the resource selection window for sidelink measurement reporting to satisfy its maximum latency requirement. Specifically, the WTRU may select the resource selection window such that the time gap to the latest resource of the resource selection window is smaller than the maximum latency requirement.

For example, the WTRU may determine the resource selection window for sidelink positioning measurement based on the periodicity of the SL-PRS pattern. Specifically, the WTRU may determine the resource selection window of sidelink positioning measurement reporting such that the time gap to the latest resource of the selection window occurs before the next one or N SL-PRS reception resources. The value of N may be determined based on the sidelink positioning measurement reporting configuration, which may be used to determine the number of SL-PRS resources the WTRU uses to measure a certain sidelink positioning measurement parameters.

For example, the WTRU may select a short resource selection window for sidelink positioning measurement report for a low latency positioning service requirement. The WTRU may select a long resource selection window for a high latency positing service requirement. Specifically, the WTRU may be (pre-) configured multiple resource selection window for sidelink positioning measurement reporting, each window may be associated with one latency requirement of the positioning service. The WTRU may then determine which window to select based on the associated latency requirement of the positioning service.

For example, the WTRU may determine the resource selection window for the sidelink positioning measurement report based on the indication from another WTRU. Specifically, the WTRU may receive the desired latency requirement of sidelink positioning report from another WTRU (e.g., target WTRU) via PC5 RRC and/or NAS message. The WTRU may then determine the resource selection window of sidelink positioning measurement report message according to the indication from the peer WTRU.

For example, the WTRU may receive the sidelink positioning measurement report configuration from another node. The WTRU may then determine the resource selection window for the measurement report based on the measurement report configuration. Specifically, if the periodicity of the configured report is smaller than a threshold, the WTRU may select the resource selection window for the measurement report being equal to the measurement report periodicity. Otherwise, if the periodicity of the measurement report configuration is larger than a threshold, the WTRU may select a fixed resource selection for sidelink positioning measurement report.

Methods for WTRU scheduled SL-PRS transmission/reception and reporting are also disclosed. The WTRU may determine the SL-PRS transmission parameters. In one solution, the WTRU may determine the SL-PRS transmission parameters, which may include one or any combination of the following: the number of subchannels used for each SL-PRS resource; the number of symbols/slots used for each SL-PRS transmission resource; comb value; the number of SL-PRS resources for each SL-PRS resource set; the number of repetitions; sequence ID; cyclic shift; muting pattern; periodicity of the SL-PRS; the SL-PRS transmission duration and/or the number of SL-PRS transmission periods; and time/frequency offset.

The WTRU may determine the QoS of a SL-PRS resource/transmission. In one solution, the WTRU may determine the QoS of a SL-PRS transmission/resource, which may include one or any combination of the following parameters: the priority of the SL-PRS transmission/resource; the reliability of the SL-PRS transmission/resource; and latency requirement of the SL-PRS transmission.

The WTRU may determine the QoS of the SL-PRS resource/transmission based on one or any combination of the following fixed, (pre-)configuration, implicit/explicit indication from another WTRU or from gNB, and one or more multiple parameters of the set of SL-PRS transmission parameters.

For example, the priority associated with the SL-PRS resource is fixed to be the highest priority (e.g., priority 1) or lowest priority (e.g., priority 8).

For (pre-)configuration, in one example, some QoS parameters (e.g., priority, reliability) of the SL-PRS resource/transmission may be (pre-)configured per resource pool. Specifically, the WTRU may be (pre-) configured multiple SL-PRS resource pool in which each resource pool may be associated with a set of QoS parameters. The WTRU may then determine the QoS parameters of the SL-PRS resource/transmission based on the resource pool in which the WTRU perform SL-PRS transmission. In another example, some QoS parameters of the SL-PRS may be determined per positioning service.

For implicit/explicit indication from another WTRU or from gNB, in one example, a WTRU (e.g., P-WTRU) may request the WTRU (e.g., A-WTRU) to transmit SL-PRS. The QoS parameters of the SL-PRS resource/transmission may be indicated in the request message. For example, the WTRU may indicate the expected SL-PRS reception window to other WTRUs. The other WTRU, upon receiving the request, may perform SL-PRS resource allocation and transmission within the requested window. Alternatively, one WTRU may indicate the QoS of the SL-PRS transmission of another WTRU during the control signaling exchange procedure (e.g., PC5-RRC messages).

For one or multiple parameters of the set of SL-PRS transmission parameters, in one example, the WTRU may determine the QoS of a SL-PRS resource/transmission based on one or multiple parameters associated with the SL-PRS transmissions. For example, the WTRU may determine the priority of a SL-PRS resource based on the number of symbols, the bandwidth, the number of repetitions, and/or comb value of the SL-PRS resource. In another example, the WTRU may determine the QoS of a SL-PRS resource/transmission based on the periodicity of the SL-PRS transmission. Specifically, the WTRU may be (pre-)configured a mapping between the priority the SL-PRS resource and the periodicity of the SL-PRS transmission. The mapping may associate a high priority to a low SL-PRS periodicity and a low priority to a high SL-PRS periodicity.

The WTRU may indicate the QoS parameters of the SL-PRS resource/transmission. In one solution, the WTRU may indicate the QoS parameters of the SL-PRS resource in an associated transmission, which may be used to indicate SL-PRS transmission. Specifically, the WTRU may use one or any combination of the following to indicate the QoS parameters of the SL-PRS resource/transmission: SCI; MAC CE; RRC; and NAS message.

The WTRU may use QoS of the SL-PRS transmission/resources in different procedures. The QoS parameters of the SL-PRS resource/transmission may be used to perform one or any combination of the following procedures: resource allocation for SL-PRS transmission; determine the availability of a SL-PRS resource and UL/SL prioritization. For example, the WTRU may use the priority of the SL-PRS resource/transmission to determine the resource selection window for the SL-PRS resource/transmission.

The WTRU may use QoS parameters of the SL-PRS resource/transmission for SL-PRS resource (re)selection. In one solution, the WTRU may use QoS parameters of the SL-PRS transmission to perform resource (re)selection. For example, the WTRU may use the latency requirement of SL-PRS transmission to determine the resource (re)selection window of SL-PRS resource. Specifically, the WTRU may determine the selection window of SL-PRS resource such that the latest possible SL-PRS resource is within the latency requirement of the SL-PRS transmission. For example, the WTRU may use the reliability requirements of the SL-PRS transmission to determine the number of repetitions for SL-PRS, the comb value, and/or the number of symbols used for one SL-PRS transmission.

The WTRU may use QoS parameters of SL-PRS resource/transmission to determine the availability of a SL-PRS resource. In a solution, the WTRU may determine the availability of a SL-PRS resource based on the QoS parameters of the SL-PRS resource/transmission. For example, the WTRU may be (pre-)configured a SL-RSRP or RSSI threshold, which may be a function of one of the QoS parameters of the SL-PRS resource. The WTRU may then determine the availability of the SL-PRS based on the SL-RSRP of the associated transmission which may be used to reserve/indicate the SL-PRS resource. Specifically, if the SL-RSRP or SL-RSSI of the associated transmission is greater than a threshold, the WTRU may determine that the SL-PRS resource is not available; otherwise, if the SL-RSRP or SL-RSSI of the associated transmission is smaller than the threshold, the WTRU may determine that the SL-PRS resource is still available.

The WTRU may use QoS parameters of SL-PRS resource/transmission to perform prioritization between UL and SL. The WTRU may perform UL/SL prioritization based on the QoS parameters of the SL-PRS transmission. In one scenario, if the WTRU cannot perform UL transmission and SL-PRS transmission simultaneously, the WTRU may prioritize UL transmission or SL-PRS transmission based on the priority of each transmission. The WTRU may drop the transmission with lower priority. In another scenario, if the WTRU cannot perform UL transmission and SL-PRS reception simultaneously, the WTRU may prioritize UL transmission or SL-PRS reception based on the priority of UL transmission and SL-PRS reception.

The WTRU may determine the SL-PRS transmission parameters. In one solution, the WTRU may determine the SL-PRS transmission parameters based on one or any combination of QoS requirement of the positioning service, CBR of the resource pool and periodicity of positioning measurement reporting. For QoS requirement of the positioning service, for example, the WTRU may determine the number of subchannel for one SL-PRS resource, number of symbols per SL-PRS resource and/or the comb value based on the positioning accuracy requirement of the WTRU. Specifically, the WTRU may choose high number of subchannels, high number of symbols per SL-PRS resource, and/or small comb value (e.g., high SL-PRS density) for high positioning accuracy requirement. Otherwise, for low positioning accuracy requirement, the WTRU may choose small number of subchannels, small number of symbols per SL-PRs resource, and/or larger comb value (e.g., low SL-PRS density).

For CBR of the resource pool, for example, the WTRU may be (pre-)configured the maximum number of subchannels, number of symbols, number of repetition, and/or SL-PRS maximum density per CBR range of the resource pool. The WTRU may then determine SL-PRS transmission parameters to satisfy the (pre-)configuration per measured CBR.

For the periodicity of positioning measurement reporting, for example, the WTRU may determine the SL-PRS periodicity based on the positioning measurement periodicity. Specifically, the WTRU may determine the periodicity of SL-PRS to be N times the periodicity of positioning measurement reporting, and the offset of the two periodicities may be similar. The value of N may be determined based on the QoS of the positioning service.

The WTRU may trigger SL-PRS transmission/reception. In one solution, the WTRU may trigger SL-PRS transmission/reception for positioning measurement and reporting. The triggering conditions may be based on one or any combination of request from other WTRU, reception of SL-PRS transmission/reception scheduling from gNB, and SL-PRS reception from other WTRU.

For request from other WTRU, for example, the WTRU may trigger SL-PRS transmission/reception based on the request from another WTRU. In one approach, the WTRU may request another WTRU to transmit SL-PRS. The WTRU may indicate the expected window to receive SL-PRS and associated SL-PRS parameters. The response WTRU may perform resource selection for SL-PRS and perform SL-PRS transmission. In another approach, the request WTRU may reserve a resource for the other WTRU to perform SL-PRS transmission. The response WTRU may use the reserved resource to perform SL-PRS transmission.

For reception of SL-PRS transmission/reception scheduling from gNB, in one example, the WTRU may receive scheduling resource for SL-PRS transmission/reception. The message may indicate whether the resource may be used for SL-PRS transmission or SL-PRS reception. For example, the WTRU may receive an DCI scheduling a SL-PRS resource, in which one bitfield may be used to indicate whether the WTRU use the resource for transmission or for reception.

For SL-PRS reception from other WTRU, for example, the WTRU may trigger SL-PRS transmission upon SL-PRS reception from other WTRU. This approach may be used in RTT positioning technique. The SL-PRS transmission from the peer WTRU may implicitly/explicitly indicate the maximum latency to transmit SL-PRS and the SL-PRS transmission parameters. For example, the WTRU may determine whether to transmit SL-PRS (e.g., for RTT method) based on whether the WTRU successfully receive SL-PRs from the peer WTRU. Specifically, if the WTRU successfully receive SL-PRs from the peer WTRU, the WTRU may trigger SL-PRs transmission; otherwise, if the WTRU does not successfully receive SL-PRs from the peer WTRU, the WTRU may not trigger SL-PRS transmission. The WTRU may implicitly/explicitly indicate the failure of SL-PRS reception and potentially request another SL-RS retransmission.

The WTRU may determine whether it is allowed to trigger SL-PRS transmission/reception. In one solution, the WTRU may be determined whether it is allowed to trigger SL-PRS transmission and/or request other WTRU to transmit SL-PRS based on one or any combination of the following configurations.

The number of SL-PRS transmissions within periods may be used. For example, the WTRU may be (pre-)configured the maximum number of SL-PRS transmissions within a period. For each SL-PRS transmission, the WTRU may determine whether the number of SL-PRS transmissions within a period is smaller than a threshold. The WTRU may determine not to transmit SL-PRS if the number of the SL-PRS transmission is greater than the maximum (pre-)configured threshold.

The last SL-PRS transmission may be used. For example, the WTRU may be (pre-)configured the minimum gap between two SL-PRS transmissions. The WTRU may determine not to transmit the next SL-PRS if the time-gap between two SL-PRS resources is smaller than the minimum (pre-)configured threshold.

The number of SL-PRS transmission request within a period may be used. For example, the WTRU may be (pre-)configured the maximum number of SL-PRS transmission request per period. The WTRU may determine whether to request another SL-PRS transmission based the number of SL-PRS transmission the WTRU has requested during the period. If the number of SL-PRS transmission request is smaller than the maximum (pre-)configured requests, the WTRU may request another SL-PRS transmission. Otherwise, the WTRU may not to request another SL-PRS transmission.

The last SL-PRS transmission request may be used. For example, the WTRU may be (pre-) configured the minimum gap between two SL-PRS transmission requests. The WTRU may not be allowed to request another SL-PRS transmission if the WTRU has made a SL-PRS transmission within the minimum (pre-) configured time gap.

The CBR of SL-PRS resource pool may be used. In one example, the WTRU may be (pre-) configured whether to request SL-PRS transmission based on the CBR of the SL-PRS resource pool. If the CBR of the SL-PRS resource pool is larger than a threshold, the WTRU may not request another WTRU to transmit SL-PRS. Otherwise, if CBR of the SL-PRS resource pool is smaller than the threshold, the WTRU may request other WTRU to transmit SL-PRS.

The WTRU may reserve SL-PRS transmission resources for a group of WTRUs. In one solution, a WTRU (e.g., P-WTRU) may reserve/indicate SL-PRS transmission resources for a group of WTRU s (A-WTRU s). In one approach, the WTRU may use one transmission associated with its SL-PRS transmission to reserve the SL-PRS transmission resources for a group of WTRU s. In another approach, the WTRU may use a request message to reserve SL-PRS transmission resources for the group of WTRU s. In the SL-PRS reservation transmission, the WTRU may use the first stage SCI to reserve SL-PRS resources for a group of A-WTRU s. In one approach, the WTRU may then use second stage SCI, MAC CE, or PSSCH data to indicate mapping between WTRU in the group and each reserved SL-PRS resources. In another approach, the mapping between each reserved SL-PRS resources may be (pre-)determined based on the WTRU ID in the group (e.g., member ID in the group), (pre-)defined during the positioning service establishment procedure.

The WTRU may determine the for SL-PRS transmission parameters. In one solution, the WTRU may determine SL-PRS transmission parameters, which may be based on one or any combination of the following described conditions.

The QoS requirement of the positioning service may be used. In one example, the WTRU may determine the number of subchannels, symbols, and/or comb value for SL-PRS transmissions based on the positioning accuracy requirements of the positioning service. Specifically, for high positioning accuracy requirement, the WTRU may use a large number of subchannels for SL-PRS transmission. Otherwise, for low positioning accuracy requirement, the WTRU may use a small number of subchannel for one SL-PRS transmission. In another example, the WTRU may determine the number of SL-PRS symbols, comb values, and/or number of SL-PRS repetitions based on the accuracy requirement of the positioning service and/or reliability requirement of the positioning service. In another example, the WTRU may determine the periodicity SL-PRS transmission based on the latency requirement of the positioning service, the positioning measurement reporting periodicity of the positioning service.

The positioning measurement report periodicity may be used. For example, the WTRU may determine the periodicity of the SL-PRS transmission based on the periodicity of the positioning measurement report.

The sidelink channel between the transmitter and the receiver of SL-PRS, which may be determined based on the Tx-Rx distance and/or SL-RSRP measured in one of the transmission channels between two devices may be used. In one example, the WTRU may determine the number of symbol and/or comb value based on the distance between the Tx and Rx. For example, the WTRU may use the high number of symbols per PRS resources and/or high number of repetitions for high distance between two WTRU s. The WTRU may use small number of symbols per PRS resources and/or small number of repetitions for small distance between two WTRU s.

The number or SL-PRS Rx(s) and/or SL-PRS Tx(s), which may be determined based on the number of assistant WTRU s (i.e., A-WTRU s) to support positioning for one WTRU (e.g., P-WTRU) may be used.

The WTRU may trigger positioning measurement reporting. In one solution, the WTRU may trigger SL-PRS transmission/reception for positioning measurement and reporting. The triggering conditions may be based on one or any combination of reception of SL-PRS from another WTRU, reception of DL-PRS from a gNB, WTRU transmission of SL-PRS, and WTRU transmission of UL-PRS.

The WTRU may determine positioning measurement in which SL-PRS resources to report. In one solution, the WTRU may monitor and measure in multiple SL-PRS resources. The WTRU may determine which SL-PRS resource(s) to report based on one or any combination of the following described conditions.

All SL-PRS resources in the period may be used. For example, the WTRU may determine to report all positioning measurement associated with all SL-PRS resources. This approach may be motivated for the transmission WTRU s to be aware of the channel in each SL-PRs transmission.

SL-RSRP associated with each SL-PRS resource may be used. In one example, the WTRU may report positioning measurement of X SL-PRS resources having highest SL-RSRP. The number of X may be indicated from the other WTRU or (pre-)configured by the network. In another example, the WTRU may report positioning measurements of the resources having SL-RSRP being greater than a threshold. The threshold may be (pre-)configured by the network or indicated from the SL-PRs transmission WTRU.

LOS/NLOS associated with each SL-PRS resource may be used. For example, the WTRU may perform positioning measurement reporting from the resources deemed to be LOS.

The WTRU may determine the QoS of the positioning measurement reporting TB. In one solution, the WTRU may determine the QoS of the positioning measurement reporting TB. The QoS may include one or any combination of the following parameters: the priority of the TB, the reliability of the TB, the packet delay budget (PDB) of the TB, and the periodicity of the positioning measurement reporting.

The WTRU may determine the resource (re)selection window for positioning measurement reporting. In one solution, the WTRU may determine the resource (re)selection window for positioning measurement reporting, which may be within the window [n+X1, n+X2], in which n may be the slot to trigger resource (re)selection for positioning measurement reporting, X1 may be the first possible slot and X2 may be the last possible slot to transmit positioning measurement reporting. The WTRU may determine slot n, the value of X1 and/or X2 based on one or any combination of the following.

An indication from other WTRU may be used. For example, the report reception WTRU may indicate the expected window of the positioning measurement reporting. The WTRU may then determine the value of n, X1, and X2 based on the indicated expected window from the peer WTRU.

Positioning measurement capability of the WTRU may be used. For example, the value of X1 and/or n may be determined based on the positioning measurement capability of the WTRU, which may be further depends on the SL-PRS transmission parameters (e.g., the number of subchannels, the number of symbols, comb values, etc.).

QOS of the positioning measurement reporting TB may be used. For example, the WTRU may determine the small value of X2 for low latency and/or high priority positioning measurement reporting TB. Otherwise, the WTRU may select a high value of X2 for high latency or low priority positioning measurement reporting TB.

QoS of the SL-PRS resources/transmissions used for positioning measurement may be used. For example, the WTRU may determine the small value of X2 for the high associated SL-PRS resources priority. Otherwise, the WTRU may select a high value of X2 for low associated SL-PRS resources priority.

The parameters associated with SL-PRS transmissions, CBR of the resource pool, and the number of A-WTRUs in the group may also be used.

The WTRU may forward the sidelink measurement report for another WTRU. In one solution, for WTRU assisted positioning service, a WTRU (e.g., target WTRU) may receive sidelink positioning measurement report from another WTRU. The WTRU may then determine to forward the measurement report to the network. The WTRU may further indicate one or any combination of the following parameters in the sidelink measurement reporting message: the reporting WTRU ID, the location of the WTRU, and the group ID.

Methods for autonomous positioning transmission and reporting are also included. For example, a WTRU request the other WTRU to transmit its position. In one approach, the WTRU may request the other WTRU to transmit its position, the WTRU may be (pre-)configured an ID (e.g., destination ID) to transmit the position request message. The WTRU may include the ID in the positioning request message. Specifically, the WTRU may use one or any combination of the following messages to request the position of the WTRU: SCI, MAC CE, RRC, and NAS.

The WTRU may transmit its position information. In one approach, the WTRU may transmit its position information which may include one or any combination of Zone ID, absolute position and error bound, the speed, heading, for example. The WTRU may be (pre-)configured an ID (e.g., destination ID) to transmit the position information message. The WTRU may include the ID in the message. In one approach, the WTRU may transmit its position information periodically. In another approach, it may report its position information based on one or any combination of triggers including the change in its position information. In one example, the WTRU may report its position if it changes the zone ID. The WTRU may report its position if the change in the error bound is greater than a threshold. The threshold may be (pre-)configured by the network (e.g., LMF/gNB).

The change in PRS configuration may also be used. For example, the WTRU may transmit its positioning information when it receives PRS reconfiguration from the network or when it changes the SL-PRS configuration.

The change in coverage status may also be used. For example, the WTRU may transmit its positioning information when it changes from in coverage to out of coverage or from out of coverage to in coverage.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for a WTRU to provision sidelink (SL) positioning, the method comprising:
configuring the WTRU with a SL positioning service and an associated destination identification (ID);
receiving at least one of a DL-positioning reference signal (PRS) configuration and a measurement reporting configuration from a network;
transmitting request using the destination ID, the request including at least one parameter based on the group consisting of received DL-PRS configuration, measurement reporting configuration, and QoS of a positioning service and an indication if the request is initiating a SL-PRS transmission for at least one other WTRU or an SL-PRS reception for the at least one other WTRU; and
on a condition that the request is initiating an SL-PRS transmission for the at least one other WTRU, performing a SL-PRS measurement and reporting the measurement to the network.

2. The method claim 1 further comprising receiving both the DL-PRS configuration and a measurement reporting configuration from a network.

3. The method of claim 1 wherein the at least one parameter includes at least one of a group consisting of validity time, type of SL-PRS transmission request; set of anchor WTRUs, a set of SL-PRS resources, a requested SL-PRS pattern, and priority of a request message.

4. The method of claim 1 wherein the transmitting is based on at least one of the DL-PRS configuration, result of the DL-PRS measurement, and SL-PRS measurement.

5. The method of claim 4 wherein the transmitting is based on the DL-PRS configuration including a number of TRPs being smaller than a threshold.

6. The method of claim 4 wherein the transmitting is based on the result of the DL-PRS measurement being less than a threshold.

7. The method of claim 4 wherein the transmitting is based on the SL-PRS measurement being less than a threshold.

8. The method of claim 1 wherein the transmitting includes one of broadcasting and group casting using the associated destination ID.

9. The method of claim 1 wherein the performing a PRS measurement includes one of a SL-PRS and a DL (downlink)-PRS.

10. The method of claim 1 further comprising reporting SL-PRS measurements and associated anchor WTRU IDs.

11. The method of claim 1 further comprising configuring the WTRU with DL-PRS and SL-PRS reception from LMF/gNB.

12. The method of claim 1 wherein the transmitted request includes one of aperiodic and periodic SL-PRS transmission.

13. The method of claim 1 wherein the transmitted request includes at least one of a group consisting of a set of anchor WTRUs, a set of SL-PRS resources, a requested SL-PRS pattern, and a priority of the request.

14. The method of claim 1 further comprising broadcasting the transmitted request indicating the destination ID associated with the positioning service.

15. The method of claim 1 further comprising group casting the transmitted request indicating the destination ID associated with the positioning service.

16. A wireless transmit and receive unit (WTRU) comprising:
a processor; and
a transceiver, the processor and transceiver operatively coupled to provision sidelink positioning by:
configuring the WTRU with a sidelink (SL) positioning service and an associated destination identification (ID);
receiving at least one of a DL-positioning reference signal (PRS) configuration and a measurement reporting configuration from a network;
transmitting request using the destination ID, the request including at least one parameter based on a group consisting of the received DL-PRS configuration, measurement reporting configuration, and QoS of a positioning service and an indication if the request is initiating a SL-PRS transmission for at least one other WTRU or an SL-PRS reception for the at least one other WTRU; and
on a condition that the request is initiating an SL-PRS transmission for the at least one other WTRU, performing a SL-PRS measurement and reporting the measurement to the network.

17. The WTRU of claim 16 wherein the at least one parameter includes at least one of validity time, type of SL-PRS transmission request; set of anchor WTRUs, a set of SL-PRS resources, a requested SL-PRS pattern, and priority of a request message.

18. The WTRU of claim 16 wherein the transmitting is based on at least one of the DL-PRS configuration, result of the DL-PRS measurement, and SL-PRS measurement.

19. The WTRU of claim 16 wherein the transmitting includes one of broadcasting and group casting using the associated destination ID.

20. The WTRU of claim 16 wherein the performing a PRS measurement includes one of a SL-PRS and a DL (downlink)-PRS.
